(19) United States
(12) Patent Application Publication
(10) Pub. No.: US 2001/0005368 A1
(43) Pub. Date: Jun. 28, 2001

(54) Method and communication system in wireless AD HOC networks

(76) Inventor: Johan Rune, Lidingo (SE)

Correspondence Address: NIXON & VANDERHYE P.C., 8th Floor, 1100 North Glebe Road, Arlington, VA, 22201-4714, US

(21) Appl. No.: 09/729,991

(22) Filed: Dec. 6, 2000

(30) Foreign Application Priority Data
Dec. 6, 1999 (SE) 99850191.0

(51) Int. Cl. H04L 12/28; H04L 12/56; H04J 3/16

(52) U.S. Cl. 370/390; 370/338; 370/475; 370/401; 370/432; 370/469

(57) ABSTRACT

In the distribution of broadcast messages in a communication system comprising one or more networks redundant distribution is reduced. Each network consists of two or more nodes interconnected by point-to-point links. When a broadcast message is received at a node, the node decides whether to send or not to send the broadcast message to other nodes In the case where it decides not to send the broadcast message, the node avoids redundant distribution of the broadcast message by sending a cancellation of broadcast message to other nodes in the system. The message includes the broadcast message to be cancelled. The cancellation of broadcast message is then handled at nodes receiving the cancellation of broadcast message in special ways. The communication system can e.g. comprises two or more networks, and then some of the nodes are forwarding nodes, which tie the networks together and which are able to forward messages from one of the networks to another one. The nodes to which the cancellation of broadcast message is sent are then forwarding nodes.

The present invention relates to a method in a communication system, in particular a method for sending broadcast messages in wireless ad hoc networks, and also to a communication system.

### BACKGROUND

A network or more specifically a computer network is formed when two or more computers are connected to each other. Local area networks may be formed of computers located within a not too large area, such as within a company, while wide area networks may be extended over larger areas. In the networks communication can be made on fixed lines or wires or wirelessly and the devices in the networks may accordingly be connected via cables, optical fibers, and/or radio links, the communication being performed in accordance with different standard specifications such as Token Ring, Ethernet, etc.

Ad hoc networks are formed on site, usually meant for temporary use and are “self-forming” in the sense that the topology of such a network is dynamic and is not is controlled by any central function.

Bluetooth (BT) is a specification for wireless communication using a frequency hopping scheme as access method, the wavelengths used located in the unlicensed 2.4 GHz, Industrial Scientific Medical (ISM) band. The original intention of the Bluetooth specification was to eliminate cables between telephones, PC-cards (Personal Computer cards), wireless headsets, etc. by supporting communication over the radio interface, but today the Bluetooth specification defines how true ad hoc wireless networks can be formed which are intended for both synchronous traffic, e.g. voice, and asynchronous traffic, e.g. IP based (Internet Protocol based) data traffic. The intention of today is that any commodity device, such as telephones, PDAs (Personal Digital Assistants), laptop computers, digital cameras, video monitors, printers, fax machines, etc. should be able to communicate over the radio interface by means of a chip and associated software designed according the Bluetooth specification.

In the following the term “Bluetooth unit” means a device or unit having the capability of communication or being adapted to communicate according to the Bluetooth specification.

Two or more Bluetooth units connected to each other form a piconet, see FIG. 1. Within a piconet, a Bluetooth unit can have either the role of a master or master unit or of a slave or slave unit. Within each piconet, there can be only one master, and there must always be one slave, and there can be up to seven active slaves. Any Bluetooth unit can become a master in a piconet.

Furthermore, two or more piconets can be interconnected, forming a so-called scatternet, see FIG. 2. The connection point between two piconets consists of a Bluetooth unit that is a member of both piconets. A Bluetooth unit can simultaneously be a slave member of multiple piconets, but only a master in one piconet. A Bluetooth unit can act as a master in one piconet and can participate in other piconets as a slave. A Bluetooth unit can only transmit and receive data in one piconet at a time, so participation in multiple piconets is made on a time division multiplex basis.

The Bluetooth specification provides full-duplex transmission built on slotted Time Division Duplex (TDD), where each slot is 0.625 ms long. The time slots are numbered sequentially using a very large number range, which is cyclic with a cycle of 227. Master to slave transmission always starts in an even-numbered time slot, while slave-to-master transmission always starts in an odd-numbered time slot. The combination of an even-numbered time slot and its subsequent odd-numbered time slot is called a frame, except when multi-slot packets are used. There is no direct transmission between slaves in a piconet formed according to the Bluetooth specification.

The communication within a piconet is organised such that the master polls each slave according to some polling scheme. With one exception, a slave is only allowed to transmit after having been polled by the master. The slave will then start its transmission in the slave-to-master time slot immediately following the packet received from the master. The master may or may nor include data in the packet used to poll a slave. The only exception to the above principle is that when a slave has an established SCO link, as will explained below, it is always allowed to transmit in the pre-allocated slave-to-master time slot, even if not explicitly polled by the master in the preceding master-to-slave time slot.

The Open System Interconnection (OSI) reference model describes how information from a software application in one computer moves through a network medium to a software application in another computer. The OSI reference model is a conceptual model composed of seven layers, each specifying particular network functions. The physical layer defines the electrical; mechanical; procedural and functional specifications for the physical link between communicating network systems, IEEE 802 is a standard specifying a physical layer.

Each Bluetooth unit has a globally unique 48-bit IEEE 802 address. This address is called the Bluetooth unit address, BD_ADDR, which is assigned when the Bluetooth unit is manufactured and it is never changed. In addition to this, the master of a piconet assigns a local Active Member Address, AM_ADDR, to each active slave member of the piconet. The AM_ADDR, which is only three bits long; is dynamically assigned and de-assigned. The AM_ADDR is unique only within a single piconet. The master uses the AM_ADDR when polling a slave in a piconet. However, when the slave, triggered by a packet from the master addressed with AM_ADDR of the slave, transmits a packet to the as master, it includes its own AM_ADDR in the packet header. The master has no AM_ADDR.

Although all data are transmitted: in packets, the packets can carry both synchronous data, on Synchronous Connection Oriented (SCO) links mainly intended for voice traffic, and asynchronous data, on Asynchronous ConnectionLess links (ACL). For asynchronous links an acknowledgement and recommission scheme is used to ensure reliable transfer of data, as well as to forward or error correction (FEC) in the form of channel coding.

The standard format of a normal packet formed according to the Bluetooth specification is shown in FIG. 3. The AM_ADDR is located in the packet header field in which it is followed by some control parameters, e.g. a bit indicating acknowledgement or retransmission request of the previous packet, when applicable, and a header error check (HEC). The format of the payload field depends on the type of packet. The payload of an ACL packet consists of a header, a data field and a cyclic redundancy check (CRC), except AUXI type packets. The payload of an SCP packet consists of a data field. In addition, there are hybrid packets including two data fields, one for synchronous data, and one for asynchronous data. Packets in which the payload does not include a CRC are neither acknowledged nor retransmitted.

The protocol layers of a Bluetooth system are illustrated in FIG. 4. The baseband, LMP, and L2CAP represent existing specific protocols according to the Bluetooth specification, the “High level protocol or application” layer representing protocols that may or may not defined in the Bluetooth specification, while the Network layer is not defined in the Bluetooth specification.

A limitation of the Bluetooth specification is that, in the standard specification, there is no way to address and route packet from one piconet to another. The way in which inter-piconet communication is performed in a scatternet is not specified.

An important aspect of forming ad hoc networks according to the Bluetooth specification is how to support the Internet Protocol (IP) in a Bluetooth scatternet or a piconet, i.e. essentially how to run IP on top of the protocol stack according to the Bluetooth specification.

One solution proposed to run IP's to regard each piconet as an IP subnet and to run IP on top of L2CAP in each piconet.

Another solution is to regard an entire scatternet formed according to the Bluetooth specification as an IP subnet. This requires that an adaption layer, referred to as a Network Adaption Layer (NAL), is insert between L2CAP and the IP layer, see FIG. 5. The purpose of this adaption layer is to emulate a shared medium network, i.e. a broadcast medium, which is assumed by the IP layer.

The first solution suffers from a number of problems, partly due to that the piconets formed according to the Bluetooth specification are not shared medium networks. The second solution is regarded as more promising but has several drawbacks.

The NAL layer will have to support a number of features. One very basic feature that is required is a routing procedure for packets within a scatternet, i.e. emulating the IP layer so that the scatternet appears as a single shared medium network. There are several ad hoc routing procedures proposed for this purpose. Regardless of the routing scheme used, it relies on the Bluetooth units that are members in more than one piconet in order to forward packets from one piconet to another. These Bluetooth units are henceforth referred to as forwarding nodes. Depending or, the specification of the NAL layer, the master unit of a piconet having two or more slave units connected thereto may be regarded as a forwarding node, even if the master unit is not connected to more than one piconet.

A number of procedures in an IP network, e.g. the Address Resolution Protocol (ARP) and Dynamic Host Configuration Protocol (DHCP) procedures, rely on a broadcast procedure in the underlying link layer.

Many networks have support for broadcast messages. The purpose of many broadcast messages is to find a specific resource in the network or to have a specific piece of information returned For instance, the ARP requests broadcast in order to reach the node, which is assigned a certain IP address As a response, the node will return its Medium Access Control (MAC) address, which in turn can be used to send unicast messages to the node. For a scatternet formed by Bluetooth units, this is probably the BD_ADDR. Another example is when DHCP is used to assign an IP address to a newly connected node in a network. The first step of this procedure is that the new node broadcasts a DHCP_DISCOVER message, in order to locate at least one available DHCP server from which it can obtain an IP address. Another example is when random IP addresses are used in an ad homenetwork. A node that chooses a ransom IP address must make sure that this address is unique within the ad homenetwork. This is done by broadcasting a message in the ad homenetwork and including the randomly chosen IP address in the message. If a node that already uses the same IP address receives the broadcast message, it will return a response message indicating that the concerned IP address is already taken. In both these cases, the node sending the broadcast message expects to receive a reply from only one of the nodes receiving the broadcast message.

Sometimes the broadcast message can trigger a reply from multiple nodes, although the sender of the broadcast message only needs to receive one regardless of which. In true broadcast networks, i.e. shared medium networks, a broadcast message is received by all nodes at the same time and in those cases where a reply could be triggered in multiple nodes, multiple redundant reply messages are often avoided using one the following two principles:

1) The reply message is delayed for a random time interval before it is sent by a node in which a reply message has been triggered; and

2) Before the reply message has been sent, the node receives a reply message sent by another node responding to the same broadcast message, and then the node cancels its delayed reply message.

An example of a prior art solution for avoiding unnecessary traffic is disclosed in European patent application EP 0 913 965. In this solution, re-broadcasting of a message is avoided by a method in which a node receiving a broadcast messages checks from a list comprising stored identities of broadcast messages if it is supposed to forward a broadcast message. If the identity of the received broadcast message is found in the list, the broadcast message is not forwarded.

The broadcast situation is special in a network in which a broadcast message is not received by all nodes at the same time. For example a scatternet formed according to the Bluetooth specification is such a network and is therefore not a true shared medium network. Hence, there may be a significant time difference between the reception of a broadcast message in the first node and the reception of the same broadcast message in the last node.

In the Bluetooth specification, an important feature is to support broadcasting. The NAL layer translates into distribution of broadcast messages so that every node in the scatternet receives the message, while avoiding that the message is transferred in loops. Freedom of loops is usually guaranteed by giving every broadcast message a unique identity, normally the source address, i.e the address of the node sending the broadcast message, and a sequence number. A forwarding node that forwards a broadcast message must cache, i.e. store in special memory in the node called a cache memory, the unique identity of the forwarded broadcast message for a certain period of time and if a is broadcast message having the same identity as one to the cached identities is received, the message is discarded.

Furthermore, each broadcast message imposes a significant load in a scatternet formed according to the Bluetooth specification. Since it will traverse every link and has to be forwarded by every forwarding node in the scatternet, as supposed to a true shared medium network in which a broadcast message does not impose a greater network load than a unicast message.

In cases where only a single reply message to a broadcast message is required and a reply message is generated early in the broadcast distribution, the continuing distribution of the broadcast message on the scatternet is unnecessary and redundant, and may also trigger redundant reply messages. If this redundant broadcast distribution could be avoided, the load caused by broadcast messages in a scatternet could be reduced significantly.

### SUMMARY OF THE INVENTION

The present invention relates to a method for reducing redundant distribution of broadcast messages in a communication system comprising one or more networks. Each network consists of two or more nodes interconnected by point-to-point links. The system supports distribution of broadcast messages to nodes in the networks. In the method, a broadcast message is received at a node in the communication system. The node is deciding if it will send the broadcast message to other nodes. Then the node avoids redundant distribution of the broadcast message by sending a cancellation of broadcast message to other nodes in the system. The message includes the broadcast message to be cancelled. The cancellation of broadcast message is then handled at the node(s) receiving the cancellation of broadcast message in certain ways.

The present invention is also concerned with a communication system in which the method is used as well as a computer program product which when loaded into an appropriate device performs the method. The computer program product of the invention is run in the nodes of the networks forming the communication system. The invention can be implemented as a software program but also in Hardware or Firmware.

The communication system comprises at lest one network consisting of three or more nodes. In a communication system comprising two or more networks some of the nodes are forwarding nodes, which tie the networks together and which are able to forward messages from one of the networks to another one. Nodes to which the cancellation of a broadcast messages are sent are forwarding nodes.

An object of the present invention is to provide a method that reduces redundant sending of broadcast messages in a network.

Another object is to forward the broadcast message within the network until some node that receives it detects redundant distribution of the broadcast message. If this is the case a cancellation of broadcast message is forwarded to the forwarding nodes in the system instead. If a node that has received a cancellation of broadcast message then receives the pertaining broadcast message, this broadcast message is not forwarded any further in the system.

The proposed method can be used in various kinds of communication systems such as systems comprising piconets and scatternets formed according to Bluetooth specification.

A significant load in the system caused by redundant distribution of broadcast messages can be reduced, thereby saving transmission resources in the system and processing resources in the nodes to which the useless delivery of the broadcast message is avoided. In addition, unnecessary delay of other traffic is avoided.

The proposed method is of great value in networks, wherein broadcast messages are not received at the same time by all the nodes in the system, such as in a scatternet formed by Bluetooth units.

The proposed method can equally well be used in other networks different from those formed according to the Bluetooth specification, both in wired and wireless networks.

Additional objects and advantages of the invention will be set forth in the description which follows, and in part will be obvious from the description, or may be learned by practice of the invention. The objects and advantages of the invention may be realized and obtained by means of the methods, processes, instrumentalities and combinations particularly pointed out in the appended claims.

### BRIEF DESCRIPTION OF THE DRAWINGS

While the novel features of the invention are set forth with particularly in the appended claims, a complete understanding of the invention, both as to organization and content, and of the above and other features thereof may be gained from and the invention will be better appreciated from a consideration of the following detailed description of non-limiting embodiments presented hereinbelow with reference to the accompanying drawings, in which:

FIG. 1 is a schematic picture showing examples of piconets formed according to the Bluetooth specification,

FIG. 2 is a schematic picture showing examples of a scatternet formed according to the Bluetooth specification,

FIG. 3 is a diagram showing the standard baseband packet format according to the Bluetooth specification,

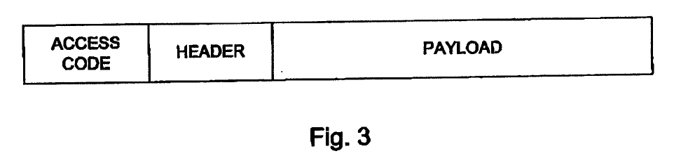

FIG. 4 is schematic picture illustrating the protocol layers according to the Bluetooth specification,

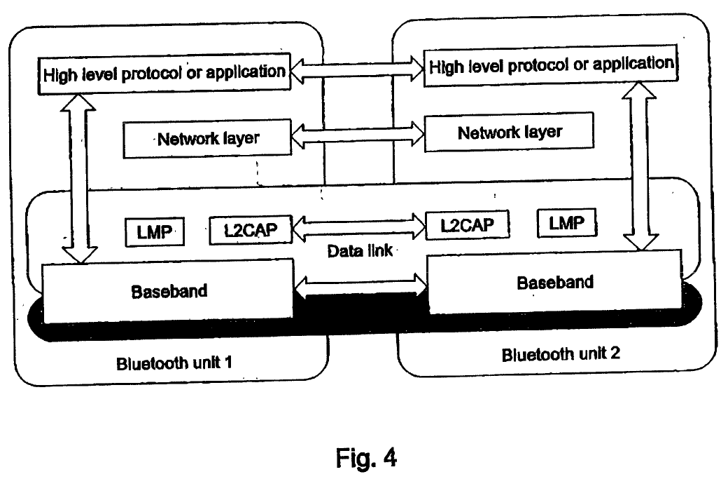

FIG. 5 is schematic picture illustrating the protocol layers according to the Bluetooth specification, including a network adaption layer,

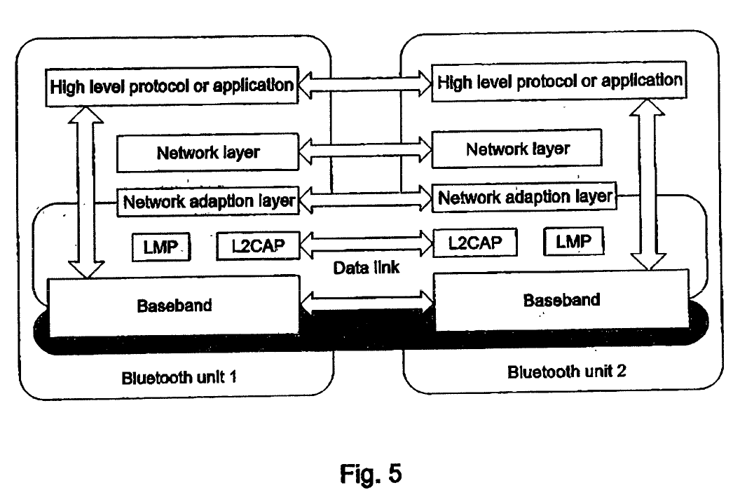

FIG. 6 is a flow chart illustrating basic steps executed in a method of sending and receiving broadcast messages in a network,

FIG. 7 is a flow chart similar to that of FIG. 6 illustrating steps executed in a more is complicated method,

FIG. 8 is a schematic picture similar to that of FIG. 2 illustrating an example of efficient use of the method of sending and receiving broadcast messages, and

FIG. 9 is a schematic picture similar to that of FIG. 8 illustrating another example of efficient use of the method of sending and receiving broadcast messages.

### DETAILED DESCRIPTION

In the following description the units described are generally assumed to be units adapted to communicate according to the Bluetooth specification and also terminology according to the Bluetooth specification will used, as has already been the case in the major part of the discussion given above, The networks formed according to the Bluetooth specification and described below are only examples of such networks. However, the method as described herein can equally well be used in many other types networks.

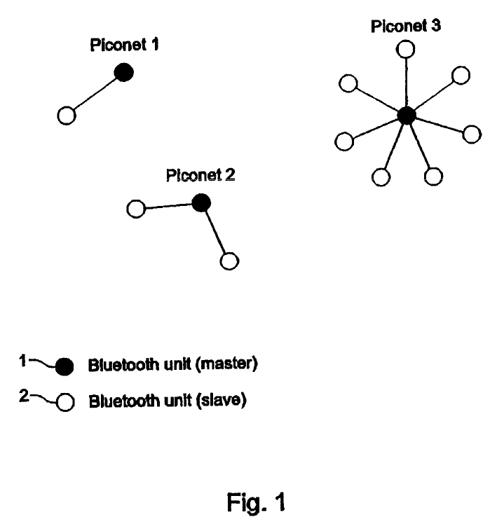

Two or more Bluetooth (BT) units can form a piconet as shown in FIG. 1, in which three different piconets Nos. 1, 2 and 3 are shown. Within a piconet, a Bluetooth unit can have either the role of a master unit, shown as filled circles 1, or of a slave unit, shown as open circles 2. Within each piconet, there can be only one master, and there must always be one, and there can be up to seven active slaves. Any Bluetooth unit can become a master in a piconet.

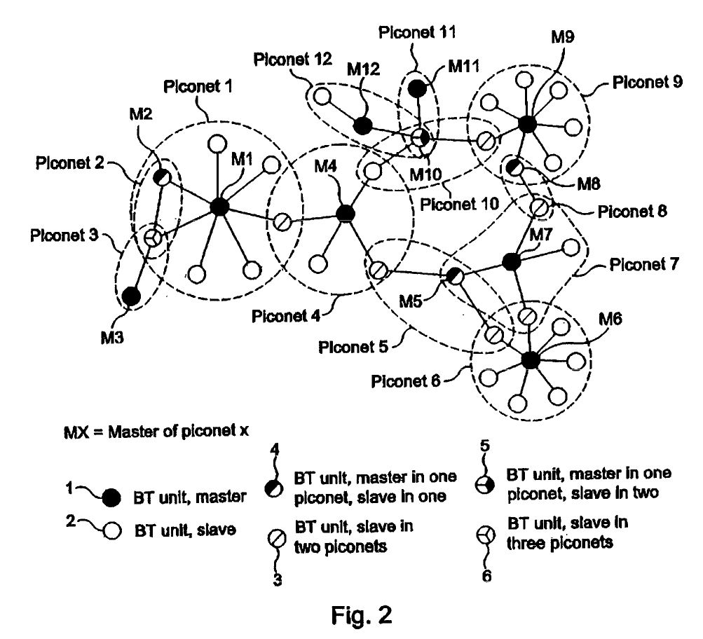

Furthermore, two or more piconets can be interconnected, forming a scatternet as shown in FIG. 2. The connection point between two piconets consists of a Bluetooth unit that is a member of both piconets, see item 3 in FIG. 2. A Bluetooth unit can simultaneously be a slave member of multiple piconets, but only a master in one piconet. A Bluetooth unit can acts as a master in one piconet, and participates in other piconets as a slave, see item 4. The Bluetooth unit 5 acts as a master in one piconet and a slave in two piconets, whereas the Bluetooth unit 6 acts as a slave in three piconets. A Bluetooth unit can only transmit and receive data in one piconet at a time, and therefore participation in multiple piconets is made on a time division multiplex basis.

The method which will be described hereinafter can be used in a communication system comprising one or more networks. The communication system can e.g. be a digital packet based—wired or wireless—system, such as a scatternet formed by Bluetooth units. Each network consists of two or more units or nodes, which are interconnected by point-to-point links. A. point-to-point link provides a single communication path between units. When there are two or more networks, some of the nodes are forwarding nodes, which are members of at least two networks and tie the networks together. These forwarding nodes can forward messages from one of the networks to another one. The system supports distribution of broadcast messages to the nodes in the networks.

A redundant distribution of broadcast messages can be achieved by a method including a cancellation of broadcast messages. In the case of a scatternet formed according to the Bluetooth specification, the method can be introduced in the NAL layer and called cancellation of broadcast

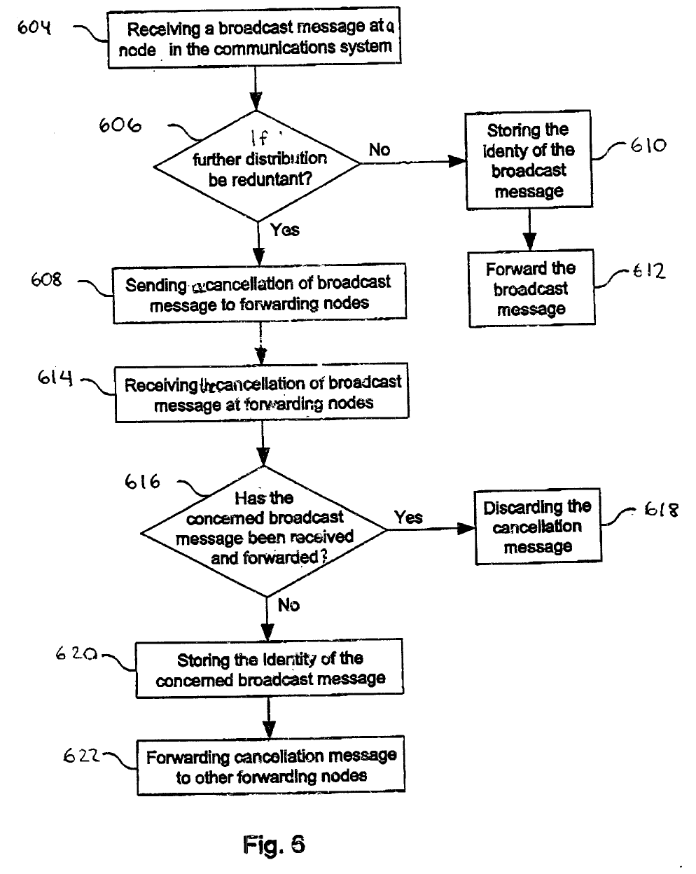

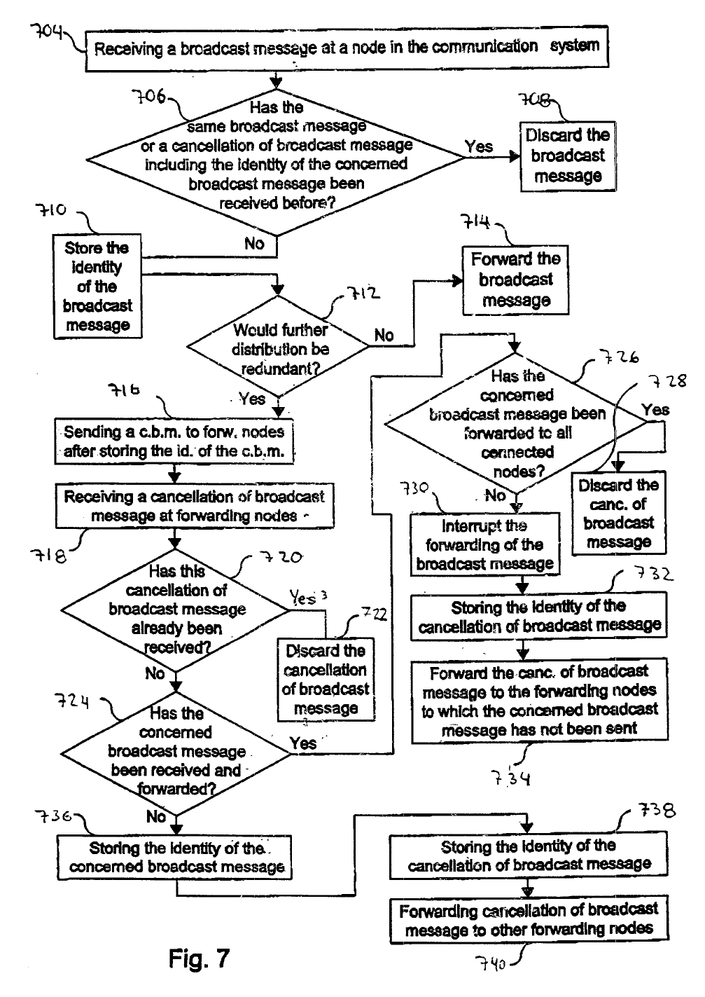

In the flow chart of FIG. 6 the basic steps of the method are illustrated, some more steps being illustrated in the more complicated flow chart of FIG. 7. In both figures it is assumed that the system consists of at least two networks. According to FIG. 6, the method starts in a block 604 in which a broadcast message is received by a node in the communication system. Next, in the block 606 the node determines whether a further distribution of the broadcast message is redundant. If it is determined that the further distribution is not redundant; the node has no reason to assume that a further distribution of the broadcast message would be redundant. The broadcast message is then handled normally and in the block 610 the node stores the identity of the broadcast message in a memory of the node. In the next block 612 the broadcast message is forwarded to all nodes in the system.

It can be determined in the block 606 that a further distribution of the broadcast message is redundant, i.e. that the node realises that a subsequent distribution of the broadcast message is redundant. For example the node can have already sent or be about to send a reply message to the broadcast message that requires only one reply message. In this case, in the next block 608 the node sends a cancellation of the broadcast message to the forwarding nodes of the system. The cancellation of the broadcast message might be sent to neighbouring forwarding nodes of the same piconet via master units, which may or may not be regarded as a forwarding node by the NAL. The cancellation of the broadcast message includes the broadcast message to be cancelled. This information e.g. includes the unique entity of the broadcast message to be cancelled, i.e. the identity of the received broadcast message.

The cancellation of broadcast message is distributed only to the forwarding nodes in the system, via master units using different alternative methods in the case of a system formed according to the Bluetooth specification. If master units are considered to be forwarding nodes, the cancellation of the broadcast message is distributed to the master units as well. For example, in a system formed according to the Bluetooth specification the NAL layer might consider them as forwarding nodes, this being dependent on the specification of the applicable NAL layer. In any case, even if the master units are not considered to be forwarding nodes, the master unit of a piconet will be traversed at least on the baseband layer, when a cancellation of broadcast message is transferred across the piconet. But even if the master units are considered to be forwarding units, a cancellation of broadcast message will not be forwarded to a master unit, if there are no other forwarding nodes connected to the piconet, provided that the presence of other forwarding nodes in a piconet is known to each forwarding node. Henceforth, the term “forwarding node” includes or does not include master units.

In addition to the included identity of the broadcast message to be cancelled, the cancellation of broadcast message itself will have to have an identity, e.g. a source address and a sequence number, to ensure a loop-free delivery of the message.

In a block 614 a forwarding node receives the cancellation of broadcast message as sent by the first node in block 608. The forwarding node will search its cache memory for the broadcast message identity that is included in the received cancellation of broadcast message. In the next block 616 it is determined whether the broadcast message has already been received and forwarded, thus whether the identity has been found in the cache memory. If the broadcast message has already been received and forwarded, the receiving node can be still in the process of forwarding the broadcast message and then this process can be interrupted and the broadcast message will not be forwarded to the remaining nodes, i.e. the nodes to which the receiving node has not yet forwarded the broadcast message. In the case where any of these remaining nodes is a forwarding node, which is not connected to the piconet containing the node from which the cancellation of broadcast message was received by the receiving node, the cancellation of broadcast message is forwarded to this forwarding node. The identity of the cancellation of broadcast message is stored in the receiving node in order to prevent the cancellation of broadcast message from being delivered in loops. If the broadcast message has already been forwarded to all the nodes connected to the receiving node, as determined in the block 616, except maybe the one from which the cancellation of broadcast message was received, the cancellation of broadcast message arrived too late and is discarded without being forwarded in block 618.

If it is determined in the block 616 that the identity is not found in the cache memory, meaning that the broadcast message indicated in the received cancellation of broadcast message has not arrived yet, and possibly never will, due to the distribution of the cancellation of broadcast message, a block 620 is executed in which the receiving node stores the identity of the concerned broadcast message, indicated in the cancellation of broadcast message, in the ache memory comprising the identities of recently forwarded broadcast messages, or in some other place in the receiving node, to prevent forwarding the message if it will be received later. Preferably, the identity of the cancellation of broadcast message itself will also have to be stored in the receiving node in order to prevent the cancellation of broadcast message from being delivered in loops, not illustrated in FIG. 6. An identity can be a source address, the address of the node where the broadcast message originated, and a sequence number. Each node will sequentially number the broadcast messages, which are created in the node. A loop-free delivery is achieved since all nodes receiving the broadcast message will temporarily store the broadcast message identity. If the same broadcast message is received a second time, this can be checked by comparing the identity of the received broadcast message temporarily stored, and the broadcast message is then discarded. In the final block 622 the receiving node forwards the cancellation of broadcast message to other forwarding nodes, i.e. neighbouring forwarding nodes connected to the same network i.e. the same piconet in case of a system working according to the Bluetooth specification, except those connected to the piconet over which the cancellation of broadcast message was received.

In the case where the node receiving the cancellation of broadcast message is a master unit, the procedure may be somewhat different. Consider the case in which the master unit has begun to distribute a received broadcast message to the slave units in the piconet, on a unicast basis. The master unit sends the broadcast message to the first slave unit in the piconet. In the subsequent slave-to-master time slot, or at least before the broadcast message has been delivered to all the slave units in the piconet, a cancellation of broadcast message is received concerning the broadcast message. The master unit will then cancel the delivery of the broadcast message to the remaining slave units in the piconet and instead forward the cancellation of broadcast message to the forwarding nodes in the piconet that have not yet received the broadcast message.

A forwarding node receiving a broadcast message, the identity of which is found in the cache memory, will discard the message without forwarding it, since the existence of the identity in the cache memory implies that either the broadcast message concerning the received broadcast message has already been previously received, or a cancellation of broadcast message concerning the received broadcast message has previously been received. Both cases are valid reasons to discard the received broadcast message.

This scheme allows a cancellation of broadcast message to stop the distribution of a broadcast message in the parts of the scatternet in which the cancellation of broadcast message arrives before the corresponding broadcast message.

A more complicated method is illustrated by the flow chart of FIG. 7. In a first block 704 a node receives a broadcast message. Then in a block 706, the node asks whether it has received the same broadcast message or a cancellation of broadcast message including the identity of the received broadcast message. If the answer is yes, the node discards the received broadcast message in a block 708. If the answer to the question in block 706 is no, the node stores the identity of the broadcast message in a block 710. Then in a block 712 is asked whether a further distribution of the broadcast message would be redundant. If the answer is no, a block 714 is executed in which the node forwards the broadcast message. If the answer to the question in block 712 is yes, a block 716 is executed in which the node sends a cancellation of broadcast message to the forwarding nodes after storing the identity of the cancellation of broadcast message.

In a block 718 forwarding nodes of the system receive the cancellation of broadcast message. Then, in a block 720 is asked in such a forwarding node whether this cancellation of broadcast message has already been received. If the answer is yes, a block 722 is executed in which the forwarding node discards the cancellation of broadcast message. If the answer to the question of block 720 is no, a block 724 is executed in which it is determined whether the broadcast message has been already received and forwarded.

If it is determined in the block 724 that the broadcast message has already been received and forwarded, a block 726 is executed, in which is asked whether the broadcast message has been already forwarded to all connected nodes. If the answer is yes, a block 728 is executed in which the forwarding node discards the cancellation of broadcast message. If the answer to the question of the block 726 is no, a block 730 is executed, in which the forwarding node interrupts the forwarding of the broadcast message. The identity of the cancellation of broadcast message is stored in a next block 732. Finally, in a block 734, the forwarding node forwards the cancellation of broadcast message to the forwarding nodes to which the broadcast message has not been sent.

If the answer to the question of the block 724 is no, a block 736 is executed in which the forwarding node stores the identity of the broadcast message. Thereafter in a block 738, the forwarding node stores the identity of the cancellation of broadcast message and finally in a block 740 the forwarding node forwards the cancellation of broadcast message to other forwarding nodes.

In essence, since the cancellation of broadcast message is only distributed among forwarding nodes—not to slave nodes—most of the load is eliminated in the parts of the scatternet where the distribution of the cancellation of broadcast message replaces the distribution of the concerned broadcast message. In addition, a cancellation of broadcast message is usually smaller the broadcast message the further distribution of which it is intended to stop. This may almost always be true since a cancellation of broadcast message does not carry any data from protocol layers above the NAL layer and thus saves the bits otherwise occupied by e.g. the IP header.

A way of further increasing the efficiency of the cancellation of broadcast method is to give cancellation of broadcast messages a higher priority than broadcast messages in general. Hence, the cancellation of broadcast mechanism can never increase the load in a scatternet.

Since the knowledge of the time when it is appropriate to send a cancellation of broadcast message resides in protocol layers above the NAL layer, possibly even in the application layer, the NAL layer must have a service primitive for the sending of a cancellation of broadcast message. This service primitive may be tied to the delivery of a received broadcast message from the NAL layer, upwards in the protocol stack, to enable inclusion of the correct broadcast message identity in the cancellation of broadcast message. To facilitate this, the identity of a broadcast message may be passed to higher protocol layers together with the contents of the concerned broadcast message.

It is also possible to let the application, in a source node, issue the broadcast message deciding whether the cancellation of broadcast mechanism is allowed for a particular broadcast message. This could be achieved by having two types of broadcast messages, one that can be cancelled by cancellation of broadcast messages and one that will be unaffected by cancellation of broadcast messages. For the latter type, no cancellation of broadcast messages would be sent. The different types of broadcast messages could be distinguished e.g. by a one bit indicator in the message header, or even by using different (dedicated) broadcast addresses.

In an alternative embodiment of the method, a node can respond to a received broadcast message and send a cancellation of broadcast message on behalf of another node. If e.g. node A is the appropriate responder, e.g. because A is the node that represents the resource which was the purpose of the broadcast message to find or which holds the information requested by he broadcast message, and a node B knows that the node A is the appropriate responder and the node B is able to generate the same response message as the node A would generate then the node B can generate the unicast response message and a cancellation of broadcast message on behalf of the node A. In a typical example, the node A would be a slave node in a piconet and the node B would be the master of the same piconet.

In another alternative embodiment of the method one node can send the cancellation of broadcast message, while another node, the appropriate responder, generates the response message. If e.g. a node A is the appropriate responder and a node B knows that the node A is the appropriate responder, but the node B cannot generate the response on behalf of the node A, e.g. because the node B knows that the node A holds the requested information, but the node B does not know the information. Thereafter, when receiving the broadcast message, the node B can send a cancellation of broadcast message and then unicast the contents of the broadcast message, including the identity such as the original source address and sequence number of the broadcast message, to the node A. The node A can then generate the actual response, message.

Another case, also an alternative embodiment of the method is useful when a node B can actually generate the response message on behalf of a node A, but the node A still has to receive the broadcast message, because one intention with the broadcast message is to cause some internal effect, e.g. a state change in the appropriate responder, i.e. node A in this case. In this case the node B can send the cancellation of broadcast message and may or may not also send the unicast response message. The contents of the broadcast message, including the identity such as the original source address and sequence number of the broadcast message, is then unicast to the node A. If the node B did not send the response message, the node A will, but if the node B did send the response message, the node A will not send any message at all. Again, in a typical situation the node B could be the master of a piconet to which the node A is connected as a slave unit.

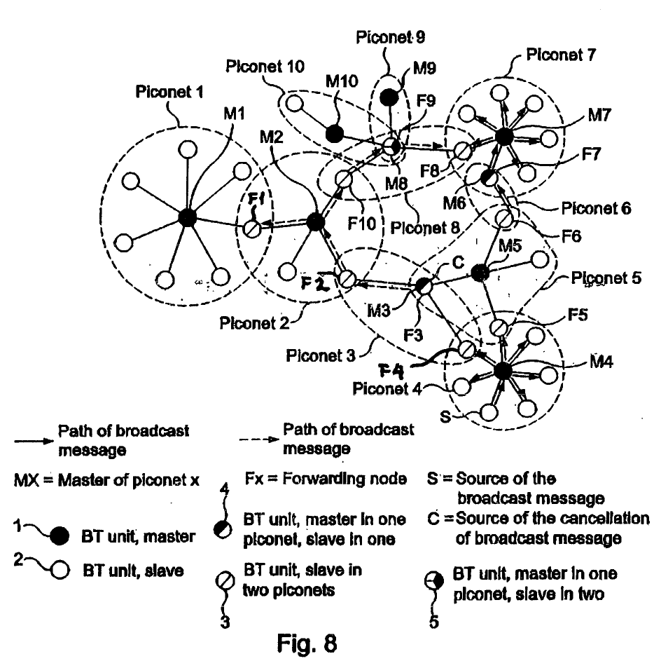

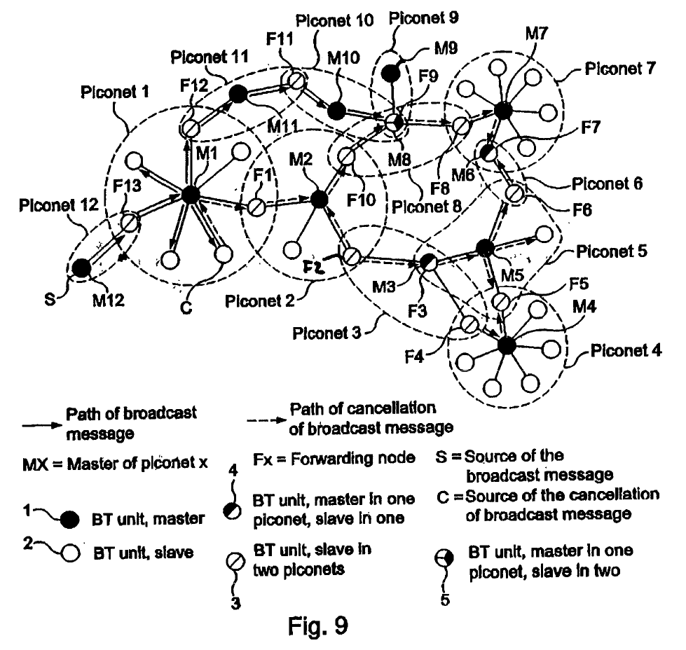

Two examples of efficient use of the cancellation of broadcast mechanism in a scatternet are illustrated in the following examples representing some typical situations. The reference numbers 1-5 in FIGS. 8-9 represent the same functional units as in FIG. 2. In FIGS. 8 and 9, master units are represented by the letter M and the number of the piconet in which they are the masters, and forwarding nodes are represented by the letter F and a sequence number. Those nodes, which are a slave in one piconet but a master in another piconet are represented by two names, an P name and an M name. In FIGS. 8 and 9, master units are also considered to be forwarding nodes.

### EXAMPLE 1

The method as used in the scatternet of FIG. 8. A broadcast message is initiated by a slave unit, a source S, in the piconet No. 4. At first, the broadcast message is forwarded to master unit M4 of the piconet No. 4. From the master unit M4 it is forwarded to the slaves of the piconet No. 4, including the forwarding nodes F4, belonging to the two piconets No. 4 and No. 3, and the forwarding node F5, belonging to the two piconets No. 4 and No. 5.

From the forwarding node F5, the broadcast message is forwarded to die master unit MS of the piconet No. 5. From the master unit MS the broadcast message is forwarded to those slaves of the piconet No. 5, that have not already received it, including the forwarding node F6, belonging to the two piconets Nos. 5 and 6. With respect to the forwarding node F3 which is a slave and a forwarding node in the piconet No. 5 and a master unit M3 in the piconet No. 3, it is in this example assumed that a cancellation of broadcast message is received by the master unit MS from the forwarding node F3 after the broadcast message has been received by the master unit MS and forwarded to the forwarding node F6 and the slave to the right in the piconet No. 5 but before the master unit M5 has sent the broadcast message to the forwarding node F3. Therefore, the master unit M5 never sends the broadcast message to the forwarding node F3.

From the forwarding node F6 the broadcast message is forwarded to the forwarding node F7, belonging to the two piconets Nos. 6 and 7 and also simultaneously being the master unit M6 of the piconet No. 6. From the forwarding node F7, it is forwarded to the master unit M7 of the piconet No. 7. From the master unit M7 it is forwarded to all the slaves of the piconet No. 7, including the forwarding node F8, belonging to the two piconets Nos. 7 and 8.

From the forwarding node F4, the broadcast message is forwarded to the master unit M3 of the piconet No. 3, which simultaneously is a forwarding node F3 in the piconet No. 3. At the master unit M3 of the piconet No. 3, the broadcast message is replaced by a cancellation of broadcast message, which is a source C of the cancellation of broadcast message, e.g. because this source C is the one having the information to be able to reply to the broadcast message. To avoid redundant distribution of the broadcast message by the node that received the broadcast message the node is sending the cancellation of broadcast message to other nodes in the system, and this includes the broadcast message to be cancelled.

The cancellation of broadcast message is now only forwarded to forwarding units, which in this example include the master units. From the master unit M3, the cancellation of broadcast message is forwarded to the master unit M5, from which it is not forwarded any more, since the master unit M5 has already received the broadcast message and can find the identity of thereof in its cache memory.

From the source C, i.e. the master unit M3, the cancellation of broadcast message is also forwarded to one of the slaves of the piconet No. 3 because this slave is a forwarding unit, i.e. F2 of the piconets Nos. 3 and 2. From the forwarding node F2, the cancellation of broadcast message is forwarded to the master unit M2 of the piconet No. 2. From the master unit M2, the cancellation of broadcast message is forwarded to the forwarding units of the piconet No. 2, i.e. the forwarding node F10 also belonging to the piconet No. 10, and the forwarding node F1 also belonging to the piconet No. 1. From the forwarding node F10, the cancellation of broadcast message is forwarded to the master unit M8 of the piconet No. 8, which also is forwarding node F9 of the piconet No. 9. From the forwarding node F9, the cancellation of broadcast message is forwarded to the forwarding node F8 of the piconet No. 8, from which it is not forwarded any more, since it is in this example assumed that the forwarding node F8 has already received the broadcast message and can find the identity thereof in its cache memory

The cancellation of broadcast message is not forwarded to any other nodes from the forwarding node F9 than to the forwarding node F8, since there are no other forwarding nodes available. The same is true for the forwarding node F1, from which the cancellation of broadcast message is not forwarded anywhere either because of the same reasons.

Thus, message delivery is avoided to the following nodes: all the Bluetooth units in the piconet No. 1, except the forwarding node F1, one of the slave units in the piconet No. 2, all the Bluetooth units, except the forwarding node F9, in the piconet No. 10, and the master unit M10 of the piconet No. 10, altogether eleven nodes.

### EXAMPLE 2

The method is used in the scatternet illustrated in FIG. 9. A broadcast message is initiated from a Bluetooth unit, a source S i.e. a master unit M12 of the piconet No. 12. From the master unit M12, the broadcast message is forwarded to the forwarding node F13 of the piconet No. 1, From the forwarding node F13 the broadcast message is forwarded to the master unit M1 of the piconet No. 1. The master unit M1 now begins to forward the broadcast message to the slaves of the piconet No. 1 one by one including the forwarding node F12 which also belongs to the piconet No. 11. From the forwarding node F12, the broadcast message is forwarded to the master unit M11 of the piconet No. 11 and from the master unit M11 to the forwarding node F11 also belonging to the piconet No. 10. From the forwarding node F11, the broadcast message is forwarded to the master unit M10 of the piconet No. 10 and from the master unit M10 to the forwarding node F9 also being the master unit M8 of the piconet No. 8 and also belonging to the piconets Nos. 8 and 9.

The master unit M1 has however not yet sent the broadcast message to the slave up to the right nor to the forwarding node F1 before it receives a cancellation of broadcast message back from the slave, the source C of the cancellation of broadcast message. At the slave unit, the source C in the piconet No. 1, the broadcast message, as already was mentioned, is replaced by the cancellation of broadcast message, since the source C avoids redundant distribution of the broadcast message by the node that received the broadcast message. The node sends the cancellation of broadcast message to other nodes in the system, and the message includes the broadcast message to be cancelled. From the source C, the cancellation of broadcast message is returned to the master unit M1 before the master unit M1 has sent the broadcast message to the slave up to the right and before it has sent it to the forwarding node F1 also belonging to the piconet No. 2. The master unit M1 now sends the cancellation of broadcast message instead to the forwarding node F1 as it is a forwarding node. From the forwarding node F1, the cancellation of broadcast message is forwarded to the master unit M2 of the piconet No. 2. From the master unit M2, the cancellation of broadcast message is forwarded to the forwarding nodes F10 also belonging to the piconet No. 8 and the forwarding node F2 also belonging to the piconet No. 3. From the forwarding node F10, the cancellation of broadcast message is forwarded to the master unit M8 of the piconet No. 8 also being a forwarding node F9 belonging to the piconets Nos. 8, 9 and 10.

In this example it is now assumed that the master unit M8 (= F9) receives the cancellation of broadcast message from the forwarding node F10 before it receives the broadcast message from the master unit M10 but the broadcast message is received from the master unit M10 before a cancellation of broadcast message is sent from the forwarding node F10 to the master unit M10. From the forwarding node F9, the cancellation of broadcast message is forwarded only to forwarding nodes and therefore it is not sent to the master unit M9 since that would be a dead end but is sent to the forwarding node F8, belonging to the piconets Nos. 7 and 8. From the forwarding node F8, the cancellation of broadcast message is forwarded to the master unit M7 of the piconet No. 7, which in this example is considered as a forwarding node and because there is another forwarding node in the same piconet. From the master unit M7, the cancellation of broadcast message is forwarded only to the forwarding node F7 of the piconet No. 7, which also is the master unit M6 of the piconet No 6, from which it is not forwarded any more because the cancellation of broadcast message arrives from the forwarding node F6.

From the forwarding node F2, the cancellation of broadcast message is forwarded to the forwarding node F3 of the piconet No. 3 which also is the master unit M3 of the piconet No. 3. From the master unit M3, the cancellation of broadcast message is forwarded to the master unit MS of the piconet No. 5. From the master unit M5, the cancellation of broadcast message is forwarded to the forwarding node F6 of the piconet No. 6. From the forwarding node F6, the cancellation of broadcast message is forwarded to the forwarding node F7, from which it is not forwarded any more, as it is assumed in this example that the forwarding node F7 has already received the cancellation of broadcast message and can find the identity thereof in its cache memory.

From the master unit M3 the cancellation of broadcast message is also forwarded to the forwarding node F4 of the piconet No. 3 also belonging to the piconet No. 4. From the forwarding node F4, the cancellation of broadcast message is forwarded to the master unit M4 which forwards it to the forwarding node F5 from which it is not forwarded any more since a cancellation of broadcast message has already been received from the master unit M5.

Thus, message delivery is avoided to the following nodes: one of the slave units in the piconet No. 1, one of the slave units in the piconet No. 2, all the slave units, except the forwarding nodes F4 and F5, in the piconet No. 4, one of the slave units in the piconet No. 5, five slave units in the piconet No. 7 and the master unit of the piconet No. 9, altogether 14 Bluetooth units.

While specific embodiments of the invention have been illustrated and described herein, it is realized that numerous additional advantages, modifications and changes will readily occur to those skilled in the art. Therefore, the invention in its broader aspects is not limited to the specific details, representative devices and illustrated examples shown and described herein. Accordingly, various modifications may be made without departing from the spirit or scope of the general inventive concept as defined by the appended claims and their equivalents. It is therefore to be understood that the appended claims are intended to cover all such modifications and changes as fall within a true spirit and scope of the invention.

What is claimed is:

1. A method for sending broadcast messages in a communication system comprising at least one network, the at least one network comprising nodes interconnected by point-to-point links, the method comprising the steps of:
a) sending a broadcast message to nodes in the at least one network, and
b) then receiving the broadcast message by nodes in the at least one network, characterized by the additional steps of:
c) a node receiving the broadcast message deciding whether to send or not to send the broadcast message to other nodes in the at least one network, the deciding based on previously received messages in the node,
d) in the case where the node decides to send the broadcast message, sending from the node the broadcast message to other nodes in the at least one network,
e) in the case where the node decides not to send the broadcast message, instead sending from the node a cancellation of broadcast message, indicating that forwarding the broadcast message is to be cancelled, to other nodes in the at least one network to avoid redundant distribution of the broadcast message, and
f) in the case of d) receiving the broadcast message by nodes, and then performing step
g) in the case of e) receiving the cancellation of broadcast message by nodes,
h) the nodes of step g) stopping sending the broadcast message to nodes in the at least one network, whereby redundant distribution of broadcast messages in the communication system is reduced.

2. A method according to claim 1, characterized in that in step h) the nodes of step g) also send from the nodes the cancellation of broadcast message to nodes in the at least one network.

3. A method according to claim 1, characterized in that in step e) the cancellation of broadcast message is made to include the received broadcast message.

4. A method according to claim 1 in the case where the communication system comprises at least two networks, which are tied together by at least one forwarding node, each forwarding node connected in the at least two networks, characterized in that sending messages is done from forwarding nodes in one network to other nodes in another network.

5. A method according to claim 4, characterised in that sending the cancellation of broadcast message in step e) is done in the forwarding nodes.

6. A method according to claim 1, characterised in that an identity of the received broadcast message is stored in the receiving node in step b).

7. A method according to claim 1, characterised in that sending the cancellation of broadcast message in step e) is done for a particular broadcast message.

8. A method according to claim 1, characterised in that the decision is made in step d) when the receiving node has sent or intends to send a reply to the received broadcast message.

9. A method according to claim 1, characterised in that the identity of the broadcast message is included in the cancellation of broadcast message in step e).

10. A method according to claim 1, characterised in that a source address and a sequence number are included in the cancellation of broadcast message to ensure loop-free delivery of the message in step e) when sending of the cancellation of broadcast message.

11. A method according to claim 1, characterised in that in steps e) and h) a memory is searched for the identity of the broadcast message, as found in the cancellation of broadcast message in step h).

12. A method according to claim 11, characterised by finding the identity of the broadcast message in the cancellation of broadcast message in the cache or like in step h) and discarding the cancellation of broadcast message if it is found.

13. A method according to claim 11, characterised by storing the identity of the broadcast message in the cancellation of broadcast message in a cache memory or the like in the receiving node in step h), when the received the identity of the broadcast message in the cancellation broadcast message is not found in the cache memory or the like.

14. A method according to claim 11, characterised by storing the identity of the broadcast message in the cancellation broadcast message in the receiving node in step h), when the identity of the broadcast message in the cancellation of broadcast message is not found in the cache memory or the like.

15. A method according to claim 11, characterised by avoiding the cancellation of broadcast messages to be forwarded to other neighbouring forwarding nodes connected to the network over which the cancellation of broadcast message was received in step h), when the identity of the broadcast message in the cancellation broadcast message is not found in the cache memory or the like.

16. A method according to claim 1, characterised in that the sending of all messages within a network goes through a master node, and the remaining nodes in the network are slave nodes connected to the master node.

17. A method according to any of claims 9 and 14, characterised by forwarding the cancellation of broadcast message to other neighbouring forwarding nodes connected to the same network, which takes place via the master node of the network if the node itself is not a master node in step h), when the identity of the broadcast message in the cancellation broadcast message is not found in the cache memory or the like.

18. A method according to any of claims 16-17, characterised by no sending of a cancellation of broadcast message to a master node if there are no other forwarding nodes in the network to send to.

19. A method according to any of claims 16-18, characterised in that when receiving a cancellation of broadcast message in a master node before having sent the broadcast message to all node slave units, he sending of the broadcast messages to the remaining slaves is interrupted and instead the cancellation of broadcast message is sent to the forwarding nodes.

20. A method according to claim 1, characterised by giving higher priority to the sending of the cancellation of broadcast message than sending the broadcast messages.

21. A method according to claim 1, characterised in that a reply to the broadcast message and/or the cancellation of broadcast message is sent from a node on behalf of another node.

22. A method according to claim 1, characterised in that after step b), checking the same broadcast message or a cancellation of broadcast message including the identity of the concerned broadcast message has been received before, and acting in accordance with the situation checked.

23. A method according to claim 22, characterised by discarding the broadcast message considering that the same broadcast message or a cancellation of broadcast message including the identity of the concerned broadcast message has been received before.

24. A method according to claim 22, characterised by deciding whether further distribution would be redundant in accordance with step d) when considering that the same broadcast message or the cancellation of broadcast message including the identity of the concerned broadcast message has not been received before.

25. A method according to claim 1, characterised in that in receiving the cancellation of broadcast message in step h), checking whether the cancellation of broadcast message has already been received.

26. A method according to claim 25, characterised in that in receiving the cancellation of broadcast message in step h), checking whether the broadcast message already has been forwarded.

27. A method according the claim 26, characterised by checking whether the concerned broadcast message has already been received and forwarded to all connected nodes in previous step.

28. A method according to claim 27, characterised by storing the identity of the cancellation of broadcast message, and forwarding the cancellation of broadcast message to other forwarding nodes, considering whether the concerned broadcast message has not been forwarded to all connected nodes.

29. A method according to claim 27, characterised in that the discarding the cancellation of broadcast message is made considering Whether the concerned broadcast message has been forwarded to all connected nodes.

30. A method according to claim 29, characterised by interrupting the forwarding of the broadcast message and storing the identity of the cancellation of broadcast message, when considering whether the concerned broadcast message has not been forwarded to all connected nodes.

31. A method according to claim 30, characterised by forwarding the cancellation of broadcast message to the forwarding nodes to which the concerned broadcast message has not been sent.

32. A communication system comprising one or more networks, each network consisting of nodes interconnected by point-to-point links, the system supporting distribution of broadcast messages to nodes in the networks, comprising means for forwarding the broadcast message to nodes in the system, means for receiving a broadcast message at a node in the communication system, characterised by:
means for deciding whether to continue to send the broadcast message to other nodes, at the receiving node,
means for avoiding redundant distribution of the broadcast message,
means for sending a cancellation of broadcast message from the nodes in the system to the other nodes including the broadcast message to be cancelled, and
means for handling the cancellation of broadcast message at the nodes.

33. A communication system according to claim 32, the communication system comprising two or more networks, which are tied together, characterised in that some of the nodes are forwarding nodes, and that they are able to forward the messages from one of the networks to another.

34. A communication system according to claim 32, characterised in that the means for sending the cancellation of broadcast message including means for sending a reply message to the broadcast message to be cancelled by the cancellation of broadcast message.

35. A communication system according to claim 32, characterised by means for storing identities of the broadcast messages and/or the cancellation of broadcast messages in the nodes.

36. A communication system according to claim 32, characterised in that the networks form a scatternet according to the Bluetooth specification.

37. A communication system according to clam 36, characterised in that the scatternet consists of piconets tied together by forwarding nodes.

38. A communication system according to claim 37, characterised in that each piconet includes one master and one or more slaves, the master being a forwarding node forwarding messages between the slaves.

39. A communication system according to claim 36 or 37, characterised in that there is only one network, and the network is a piconet consisting of one master and two or more slaves.

40. A communication system according to claim 37, characterised in that the forwarding nodes include master nodes.

41. A communication system according to claim 35 or 38, characterised in that the forwarding nodes do not include any master nodes, and the forwarding nodes forward the cancellation of broadcast messages via a lower protocol layer.

42. A computer program product directly loadable into the internal memory of a digital computer, comprising software code portions for performing steps of the methods of or the methods performed by any block or device according to any of the preceding claims when the product is run on a computer.

43. A computer program product stored on a computer usable medium, comprising readable program means for causing a computer to control the execution of steps of the methods performed by any block or device according to any of the preceding claims.
